(19) United States
(12) Patent Application Publication
(10) Pub. No.: US 2011/0089696 A1
(43) Pub. Date: Apr. 21, 2011

(54) Power generating buoy

(75) Inventors: Edward (Ned) Pettet Davis, Kihei, HI (US); John Lovberg, San Diego, CA (US); Paul Johnson, El Cajon, CA (US)

(73) Assignee: Trex Enterprises Corp.

(21) Appl. No.: 12/380,473

(22) Filed: Feb. 26, 2009

Related U.S. Application Data
(60) Provisional application No. 61/067,157, filed on Feb. 26, 2008.

(51) Int. Cl. F03B 13/18; F03B 13/20

(52) U.S. Cl. 290/53

(57) ABSTRACT

An electric power generating buoy capable of generating power by scavenging energy from ocean wave motion. The power generating buoy includes float element adapted to float up and down following wave motion and an electric generator system with a spring loaded spool mechanism adapted to drive the rotor of the electric generator. It also includes an anchor element and a tension element attached to an anchor and the spring loaded spool mechanism and adapted to spin the spring loaded spool mechanism to generate electric current when wave action causes the float element to rise relative to the anchor element. Preferred embodiments of the buoy will deliver a minimum of 100 Watts of average power from the wave motion characteristic of moderate sea state (sea state 3), with less power from slight sea state (sea state 2) and more power from higher sea states. The basic power generation scheme will rely on harnessing the mechanical energy of the wave as it repeatedly pushes the buoyant surface float against a ballast force through the distance corresponding to the wave height.

### CROSS REFERENCE TO RELATED APPLICATIONS

This application claims the benefit of Provisional Patent Application Ser. No. 61/067,157 filed Feb. 26, 2008.

### FEDERALLY SPONSORED RESEARCH

The invention described in this application was made in the course of work performed under Contract No. N00014-08-M-0275 with the United States Navy and the United States government has rights in the invention.

### FIELD OF THE INVENTION

The present invention relates to electric generators and in particular to electric generators driven by wave motion.

### BACKGROUND OF THE INVENTION

Remote ocean instrumentation and monitoring techniques often rely on floating buoys with a variety of sensors to perform missions such as ambient noise measurement, acoustic tracking or communications. The operating lifetime of small remote buoys is limited by onboard battery power. Remote acoustic sensors with hydrophone arrays, onboard RF transmitters, GPS receivers and other support electronics can draw up to 100 Watts of continuous power in operation, limiting battery life to 12 to 24 hours between recharge. This is inconvenient, and often impractical to the point that many compact sono-buoys are designed to scuttle themselves after about a day. The associated cost, as well as the environmental impact of sending large amounts of battery and electronic hardware to the bottom of the ocean, is a strong driver for developing renewable ocean power sources for semi-permanent unattended buoy deployments.

Compact, power-generating buoys will enable deployment of unattended sensor arrays for ocean monitoring and instrumentation, passive acoustic arrays for ASW and marine mammal monitoring, and long-range low-power communications relays.

Power generation from wave motion is not new; in fact, one company (Ocean Power Technology) has already demonstrated enough power generation from a single buoy (40 kW) to propose terrestrial power generation systems of 10 to 100 Megawatts using buoy arrays. However, these large (typically 5 feet or more in diameter) buoys are designed for high power and weigh over 1000 kg; impractical for dense deployment on low-power remote sensor platforms.

Pull-cord generators are well known and available from suppliers such as Potenco. These generators include a cord wrapped around a spring loaded spool connected to a ratchet and a rotor of an electric generator. When the cord is pulled the spool spins the rotor generating electricity. These units also typically include a voltage regulator and a battery that is charged by the generator. A spring element is provided to return the spool to its relaxed position after tension in the cord is released.

What is needed is a compact, low-cost, low power buoy designed specifically for powering remote sensing systems. In particular a system is needed having a sustained power goal of about 100 Watts in sea state 3 with a total weight of less than 100 kg, within the general form factor of a conventional sono-buoy.

### SUMMARY OF THE INVENTION

The present invention provides an electric power generating buoy capable of generating power by scavenging energy from ocean wave motion. The power generating buoy includes float element adapted to float up and down following wave motion and an electric generator system with a spring loaded spool mechanism adapted to drive the rotor of the electric generator. It also includes an anchor element and a tension element attached to an anchor and the spring loaded spool mechanism and adapted to spin the spring loaded spool mechanism to generate electric current when wave action causes the float element to rise relative to the anchor element. Preferred embodiments of the buoy will deliver a minimum of 100 Watts of average power from the wave motion characteristic of moderate sea state (sea state 3), with less power from slight sea state (sea state 2) and more power from higher sea states. The basic power generation scheme will rely on harnessing the mechanical energy of the wave as it repeatedly pushes the buoyant surface float against a ballast force through the distance corresponding to the wave height.

Preferred embodiments of the buoy will deliver a minimum of 100 Watts of average power from the wave motion characteristic of moderate sea state (sea state 3), with less power from slight sea state (sea state 2) and more power from higher sea states. The basic power generation scheme will rely on harnessing the mechanical energy of the wave as it repeatedly pushes the buoyant surface float against a ballast force through the distance corresponding to the wave height.

The preferred embodiment is a buoy for generating energy from wave motion which is more compact and lighter weight than what is available on the market today. It relies on an underwater sail tethered to an inflatable float at the surface that allows it to generate 100 W from a package that only weighs 100 kg (220 lbs). The inflatable float at the surface will move up and down with the action of the waves. The underwater sail or sea anchor provides a greater differential force can be generated between it and the float than could be achieved by gravity alone using a dead weight suspended below the buoy in deep ocean regions. In shallow regions the buoy can be anchored to the ocean floor.

### BRIEF DESCRIPTION OF THE DRAWINGS

FIG. 1A is a drawing of a preferred embodiment anchored at the bottom

FIG. 1B is a drawing of a preferred embodiment with an underwater sail/sea anchor.

FIG. 2 shows a spool mechanism.

FIG. 3 shows an arrangement used for developing a computer model.

FIGS. 4, 5 and 6 show model results.

FIG. 7 through 10 show lab test results,

FIG. 11 shows ocean test results.

FIG. 12 shows an electric driven auger-type anchor.

### DETAILED DESCRIPTION OF PREFERRED EMBODIMENTS

Applicants have successfully designed and built a prototype compact wave energy device and successfully tested this prototype a power in excess of 50 W. This device utilizes an inflatable float at the surface tethered to either an anchor or underwater sail that allows it to generate maximum energy from a package of a given deployment size and weight.

The basic concept of the invention is a pull-cord generator coupled to surface float, preferably an inflatable surface float. Simulations developed by Applicants answer questions such as the sea state required to generate a given amount of power for this arrangement given a certain size float and set of allowable forces. The models will also help examine the anticipated sizing of the components for the ultimate full 100-200 W operation in the future.

To calculate how much energy can be generated from such an arrangement, we look at typical sea states:
Sea State 3: 0.5-1.25 m Wave Height
Sea state 4: 1.25-2.5 m Wave Height

Additionally, 7 seconds is apparently a fairly good estimate for the periodicity of many open ocean waves.

In order to generate 100 W average power from a 1 m average wave displacement with this approach, 700 newtons of force would have to be developed on the tether (Energy=Force*Distance, hence 700 N*1 m=700 J, Power=Energy/Time, hence an average power of 100 W).

The 700 N force is generated by the float rising with the wave, and the underwater sail or anchor creating an equal and opposite counterforce underwater (the sail feature of the underwater portion of the system allows it to generate a larger counterforce than it could achieve by its mass alone given the buoyancy effects when submerged in water).

This mechanical energy is converted into electrical power by a generator coupled to a spool mechanism that the tether winds and unwinds about. It will incorporate a ratchet device (similar to what allows a bicycle to coast) and a retracting spring—Actually making its operation quite similar to the starter mechanism of a chainsaw or lawnmower (except that the output is electrical energy).

In deep water, wave energy dissipates very rapidly with depth. However there is some wave energy present down to a depth equivalent about one half the wavelength of the surface wave. For a typical open ocean wave, wavelengths can be 100 m, which means that to completely avoid the motion of the wave the hydrophone portion of the sono-buoy would have to be submerged 50 m or deeper. However, due to the rapid fall off in energy with depth, it may not be necessary to place the hydrophone portion this deep in actual practice. Trex has modeling and simulation tools available which will allow us to model the dynamics of the tether cable and its effects on the generator, float, and submerged portions of the system.

The float volume must be sufficient to provide the 700 N of force on the cable. Additional float volume is required to compensate for the weight of all of the components of the power generating bouy. Applicants estimate that a float volume of as little as 227 liters may be sufficient although some additional float volume is recommended.

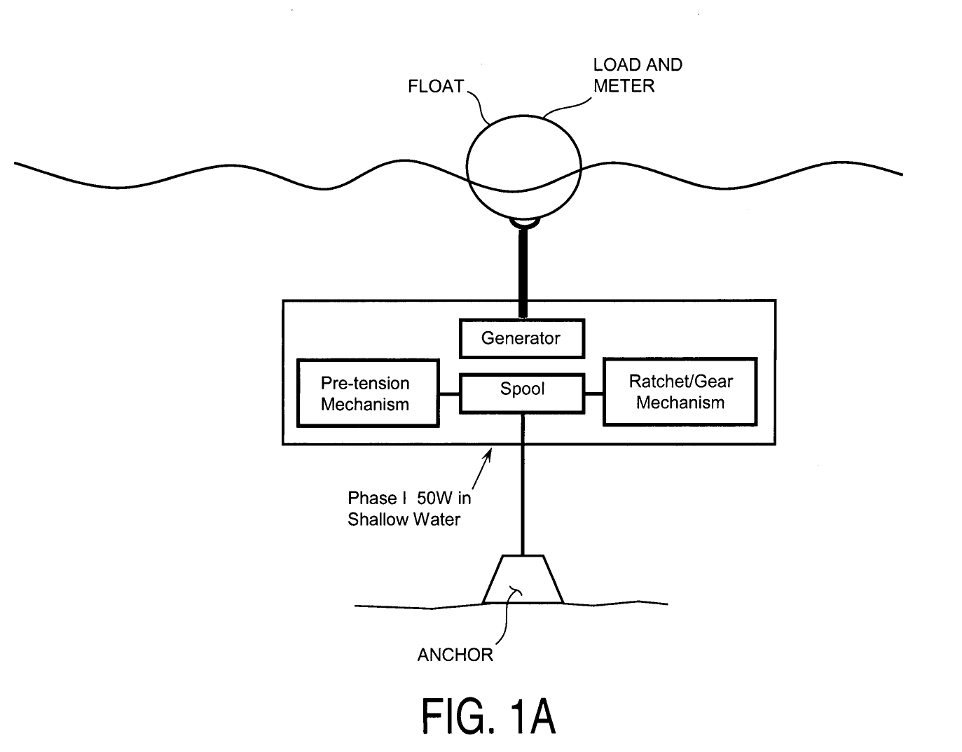

The prototype wave energy buoy built by the Applicants was anchored to the bottom as shown in FIG. 1A, but will ultimately have an underwater sail or sea anchor added to it as shown in FIG. 1B, such that a greater differential force can be generated between it and the float than could be achieved by gravity alone. The underwater sail may be as shown in FIG. 1B, potentially with small thrusters at the sail tips to enable station keeping, or may be circular (in the form of an upside down umbrella).

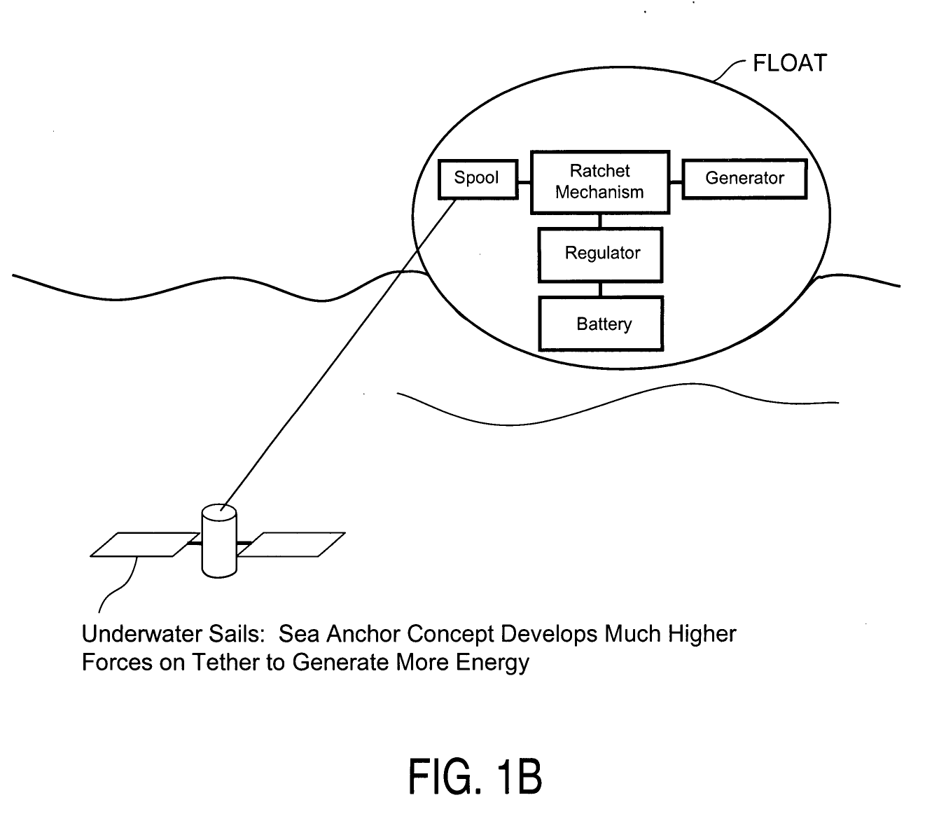

This mechanical energy is converted into electrical power by a generator coupled to a spool mechanism about which the tether winds and unwinds as shown in FIG. 2. It incorporates a ratchet device (similar to what allows a bicycle to coast) and a retracting spring—Actually making its operation quite similar to the starter mechanism of a chainsaw or lawnmower (except that the output is electrical energy).

### Modeling

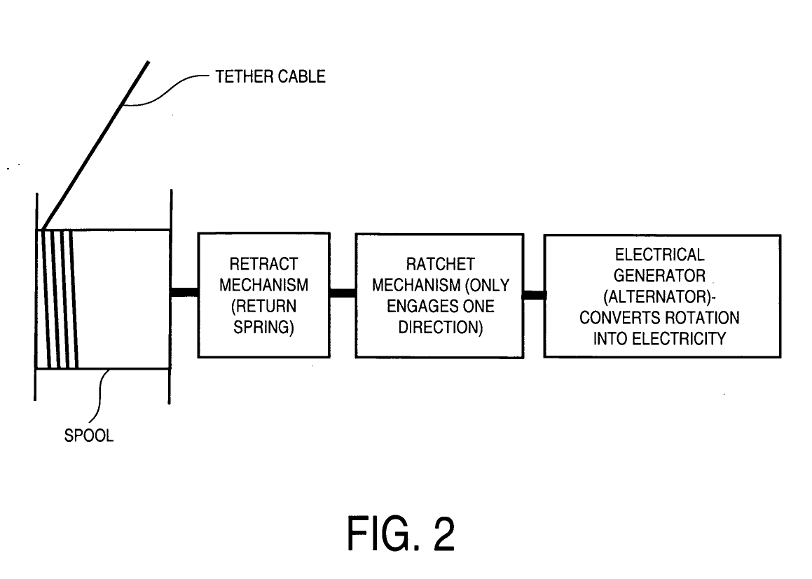

The physical model of a prototype consisted of a buoy floating on the surface, a submerged Mechanism Box below the buoy and the mooring lines that connect them to each other and to the sea floor. The model can be seen in FIG. 3. The motions of the system must be determined to predict the amount of power that can be extracted.

The motions of the buoy and Mechanism Box moored are determined by the computer program OCI/HydroMOB. The theory of OCI/HydroMOB and the Rigid Module Flexible Connector (RMFC) model is well-documented; see, for example, OCI (1999) and Ertekin et al. (1993). This program has been used (e.g., Ertekin and Riggs, 2003) in the past to successfully solve the dynamics in waves of multiple (moored) bodies connected to each other by connectors. The wave forces are determined based on linear potential theory. The constant panel, Green function method is used to determine wave exciting forces, added mass, and hydrodynamic damping on the individual buoy, the Mechanism Box and the Anchor Box. OCI/HydroMOB does not include any wave-interaction between neighboring bodies; i.e., there is no body-fluid-body interaction. The module motions are coupled through the mooring lines only. The dynamic analysis is completely linear and it does not take into account any viscous effects that may be present.

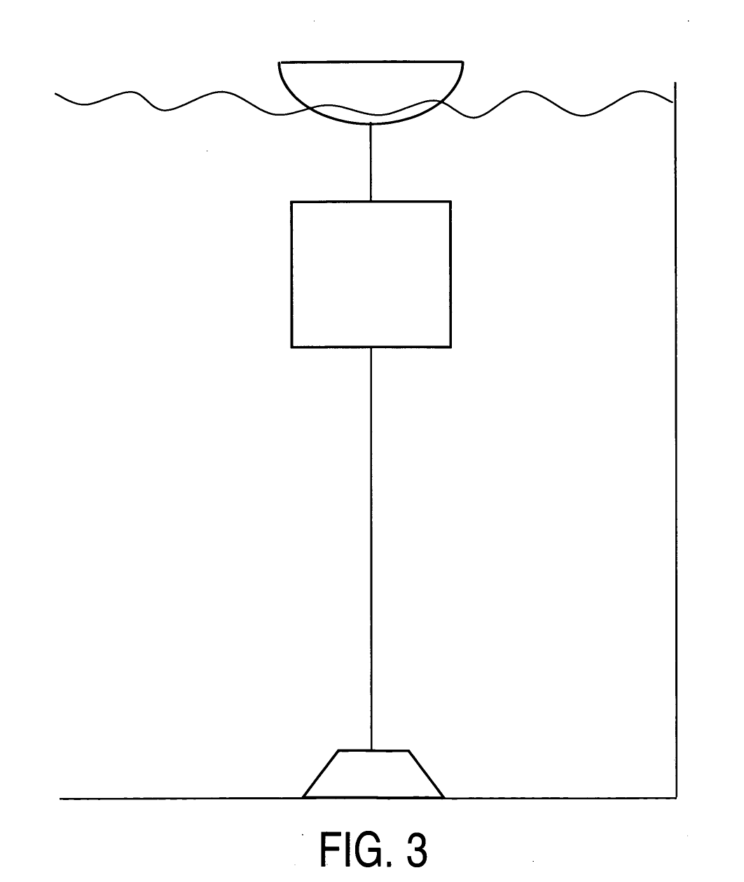

The computer program HYDRAN (OCI, 2008), which considers full interaction between the bodies, is used in addition to OCI/HydroMOB. HYDRAN has been validated extensively, see e.g., Riggs et al., 2008) FIG. 4 shows the comparison between the OCI/HydroMOB and HYDRAN results for the heave motion RAO of the Mechanism Box and for four different wave headings. These results are obtained for the steel rope axial stiffness of 3,697 lbf/ft. As seen, the hydrodynamic interaction is very weak. The analysis is carried out in the frequency domain for a range of wave frequencies with significant energy content as defined by the wave spectra. The results of the analysis are RAOs for body motions and mooring line forces. These RAOs are used, together with the wave spectra, to obtain estimates of the short-term extreme response. Bretschneider spectrum is used in the irregular-sea analysis for the two different significant wave height and peak period combinations (see the last section) used in the study. The average water depth of 33 ft is used in the hydrodynamic calculations.

The buoy is a sphere of 27 in diameter. It weighs 20 lbf in air but with 50 lbf of buoyancy there is a pretension of 30 lbf in the connector that connects it to the Mechanism Box below. Only 6 in of the buoy is submerged below the SWL. Therefore, the mass of the buoy is 1.553 slug and the mass moment is 0.7862 slug-ft². The center of gravity is on the SWL where the body coordinate origin is.

The buoy is connected to the Mechanism Box by a very stiff connector (axial stiffness 1×10⁶ lbf/ft). There is pretension of 30 lbf in this connector and therefore the two transverse components of the stiffness matrix are 60 lbf/ft each since the length of the connector is 0.5 ft. Other components of the stiffness are assumed zero, i.e., the connector provides no resistance to any rotations.

The Mechanism Box is modeled as a rectangular box of 8 inch width, 16 in height and 16 in length. It weighs 60 lbf in air. Thus its mass is 1.863 slug. As a result, the steel rope that connects the Mechanism Box to the sea floor is pre-tensioned an additional amount of 16 lbf so that the total pretension in the line is 46 lbf. The mass moment of inertias of the Mechanism Box are 0.2483 slug-ft² in the x (longitudinal) and z (vertical) directions, and 0.552 slug-ft² in the y (transverse) direction. The x axis corresponds to the zero degree wave heading. The center of gravity is assumed to be 0.5 ft below the body coordinate origin which is at the centroid of the Mechanism Box.

The Mechanism Box is connected to the sea floor (Anchor Box) by a steel rope. The steel rope is pre-tensioned a total of 46 lbf and thus the transverse components of the stiffness matrix is 1.58 lbf/ft. The axial stiffness of the steel rope is determined through experiments. The stainless steel cable is 3/16 inch diameter stranded cable made up of 7 sub-cables wrapped together in a helix. The “sub-cables” are each made up of 19 individual solid stainless steel wires each 10 mils in diameter. The helix of the cable bends around to the right and it is 7×19 (7 major strands of 19 filaments each). Its pitch is 1.15″. The laboratory experiments provided Applicants with an axial stiffness of 3,697 lbf/ft (244 lbf of tension over 0.2% strain).

Even with the stiffness of the steel rope, it is not possible to directly use it in the calculations since the rope winds about the spool mechanism. And, electricity is generated only when the buoy-mechanism-box combo moves up, i.e., over one-half of the wave cycle only. One way to model such a physical system is through the use of a viscous dashpot (damper) instead of the stiffness of the steel rope. During the dry laboratory experiments, it was determined that the winding velocity of the steel rope is approximately 2 ft/s when the pull force is about 150 lbf. Therefore, Applicants have decided to use a viscous dashpot coefficient of c=75 lbf/(ft*s) in HYDRAN calculations.

### Simulation Results

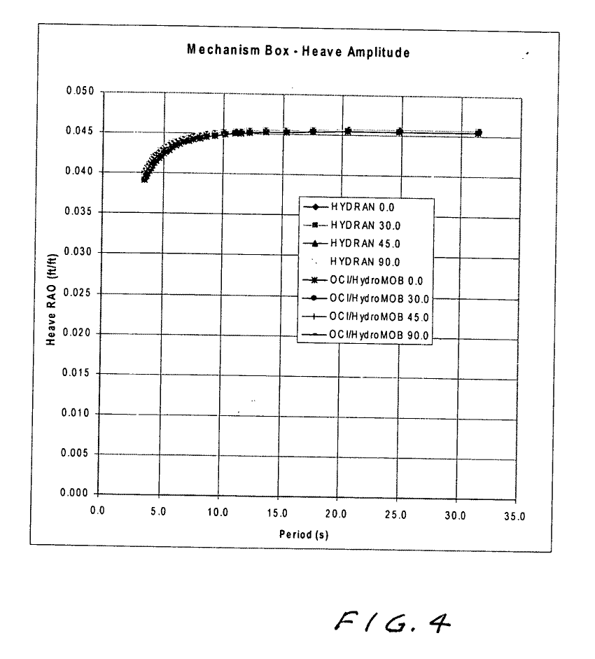

FIG. 5 shows the heave motion response amplitude operator (RAO) of the Mechanism Box for four wave headings. Without the mooring line, these results would be almost equal to 1.0. The pitch RAO (deg/ft) on the other hand showed a resonant behavior around the wave period of about 5.2 s. Note that the pitch hydrostatic stiffness is very low, due to the fact that the Mechanism Box is completely submerged and its center of gravity is close to the center of buoyancy, thereby making the metacentric height, GM, very small. Due to this resonance, the coupled equations of motion that we solve results also in a resonant behavior for the surge RAO of this moored system. Similar results for the buoy are observed. However, the focus here is on the Mechanism Box and its heave motions since it provides us with the wave power that we are after.

The amplitude of the vertical force or the axial tension (dynamic) in the steel rope that connects the Mechanism Box to the sea floor can be obtained through the following equation:

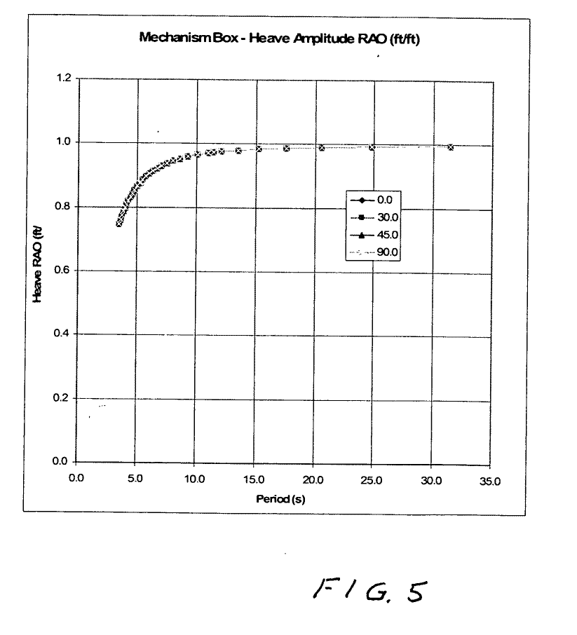

F=cωx₃, (1)

where ω is the angular wave frequency, c is the viscous dashpot coefficient and x₃ is the heave amplitude. This force is shown in FIG. 6 (per unit wave amplitude). Note that we are ready to estimate the wave power that would be available once we obtain the relation between the tension in the rope and the power available. That will be discussed in the next section.

### Line Tension Versus Wave Power

The prototype design was altered as shown in FIG. 1A to suspend the winch mechanism below the inflatable float in order to:

Preserve buoyancy of float (currently ˜300 lbf)

Not puncture and have to re-seal the inflatable skin

Allow mechanism to also displace water, minimizing the resulting loss of buoyancy

This appears to be acceptable from preliminary calculations:

700 N=157 lbf over a 1 m displacement every 7 s (waves) would yield 100 W

25 lbf return spring brings the total extension force to 182 lbf

Maximum submerged buoyancy of about 300 lbf appears possible from the buoy

This yields a design margin of almost 2 on most key parameters—likely satisfactory in this early stage of the design

In preferred embodiments the winch mechanism will generally be contained within the buoy. A prototype was fabricated in the laboratories in order to test all major subsystems of the design prior to final integration (and more expensive tests in the ocean that followed). It is important to note that the first initial prototype was not waterproof—it is simply meant to hold the components in place for dry land tests in the lab to confirm their proper performance prior to being incorporated into an appropriate water tight enclosure

Over 150 watts of peak power was generated from this system in a laboratory environment, at relatively modest pull-forces (150 lbf and less out of about 300 lbf buoyancy potentially available from an A5 buoy). Applicants did however repeat the experiment numerous times, and were able to achieve in excess of 150 W of peak power regularly and repeatedly, which bodes quite well for achieving 50 W average power in the ocean (when the waves cooperate). This can be calculated by assuming a half-sinusoidal power resulting from the wave motion (power is only generated by the pull of the cable from the wave rising, not from the retraction of the cable when the wave falls). This yields: 150 W Peak Power*0.707 RMS of the Sine Wave*0.5 Duty Cycle=53 W Average Power.

Applicants can with the above predict the available wave power. The average wave power over a wave cycle is obtained by multiplying Eq. (1) by heave velocity and integrating over the wave cycle. Recall further that we can only produce power in one-half of the wave cycle. The resulting (average) wave power is then given by

P_{AV}=cω²x₃²/4. (2)

Since about 140 lbf of pull force is predicted by the calculations when the wave amplitude is 2 ft and the wave period is between 5-7 s, we estimate that we can generate over 140 W of power. A total of 142 W peak power is needed for 50 W average power since only in half of the wave cycle the steel rope will be providing the rotation to the drum, and in the other half, it will simply be retracted by the return spring. On average, about 35.4% (100*0.707/2) of peak power obtained from the device will be available to provide power.

The significant value of the tension in the steel rope is 102 lbf in Sea State 3 and 151 lbf in Sea State 4. The short term extreme spectral results for the tension in the steel rope for two different sea states based on the Bretschneider spectrum showed that in Sea State 3, the extreme tension is 190 lbf and for Sea State 4, it is 281 lbf (for zero wave heading).

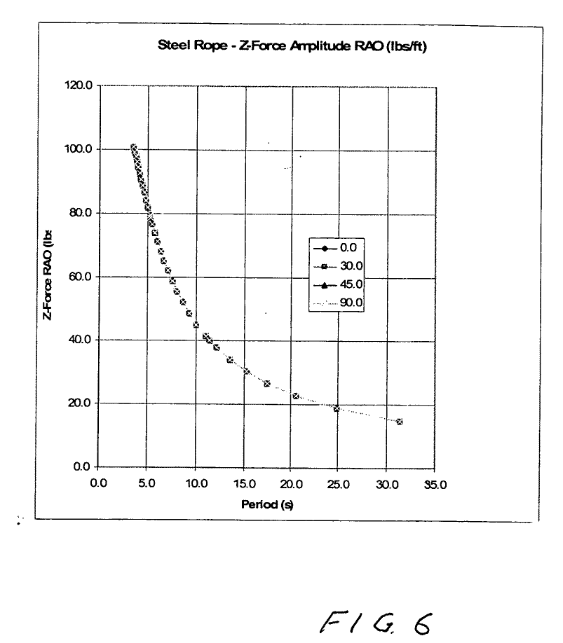

Finally, the average wave power obtained from Eq. (2) is shown in FIG. 7. for the case of an average wave amplitude of 3.075 ft. These results already take into account the fact that power is generated only in one-half of the wave cycle. However, clearly the efficiency of the system, being less than 1.0, will reduce these results somewhat.

### Preliminary Design Considerations:

Applicants obtained a size A5 inflatable (27″ diameter) buoy from a local marine supply store for $205. Because of this, we decided for strategic/logistics reasons to try to limit the size of the Phase 1 float in order to use an inflatable A5 model, which leads to some minor changes in the preliminary phase 1 concept as described below. The float is basically tear-shaped with a cable connection slot at the bottom of the buoy (top of the tear-shape).

### Generator Test Procedures & Test:

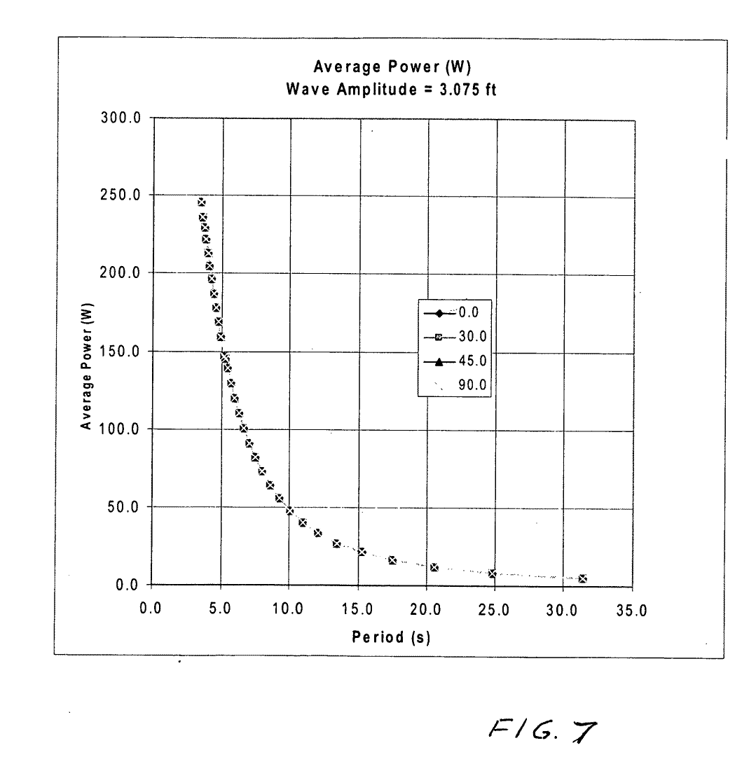

Applicants developed a crude yet surprisingly effective method of testing, sizing, and determining the necessary gearing and load characteristics of their electrical generators. By placing a candidate generator in a vise on a mill or drill press, and then changing the electrical loads and rotational speed, Applicants developed families of curves such as those shown in FIGS. 8 & 9. They also tried lowering the load impedance to 1 ohm on the second candidate generator to achieve higher power output, but its output wasn't stable at that low an impedance, so that effort was abandoned and a larger generator was ordered.

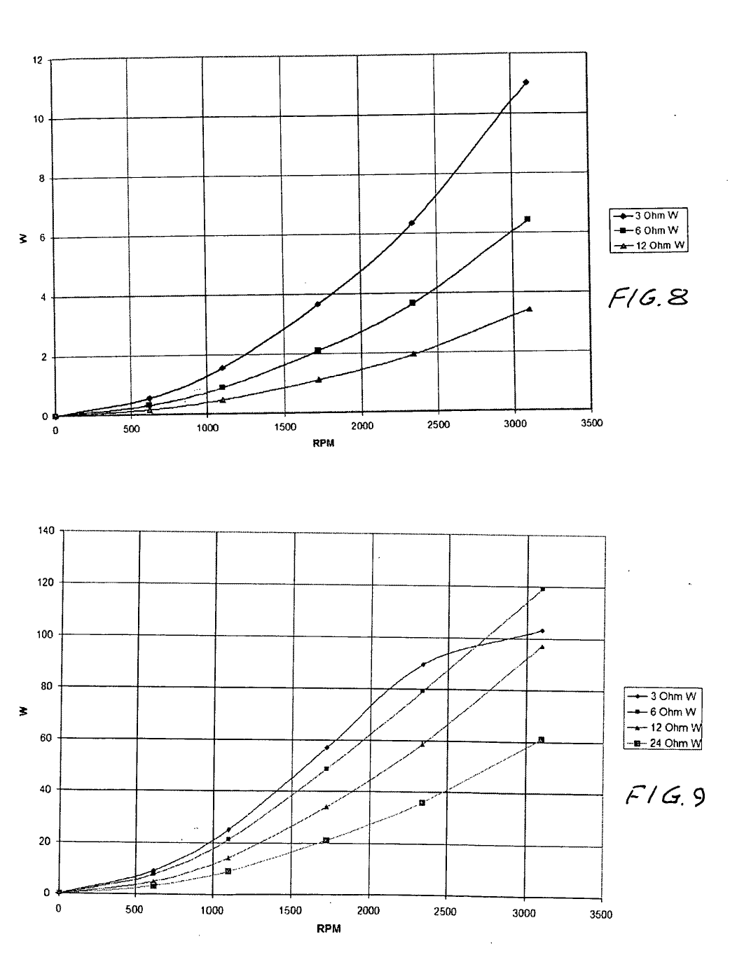

What was evident from FIGS. 8 and 9 is that to achieve 50 W at a low rotational speed (which is desirable in terms of limiting gearing), and with a larger margin of safety, we needed to order a larger generator than what we already had on the shelf. The resulting test with the new generator is shown in FIG. 9, and this was the generator used in the prototype that was built.

We also tried lowering the load impedance to 3 ohms for the final candidate generator as shown in the top trace on the graph, but the field saturated, yielding a lower power than at 6 ohms for 3100 RPM—Therefore a 6 ohm load was selected for the prototype.

### Fabrication of Laboratory Prototype:

A laboratory prototype was fabricated in our lab in order to test all major subsystems of our design prior to final integration (and more expensive tests in the water). It is important to note that this initial prototype is obviously not waterproof—It is simply meant to hold the components in place for dry land tests in the lab to confirm their proper performance prior to being incorporated into an appropriate water tight enclosure

### Results of Initial Laboratory Tests:

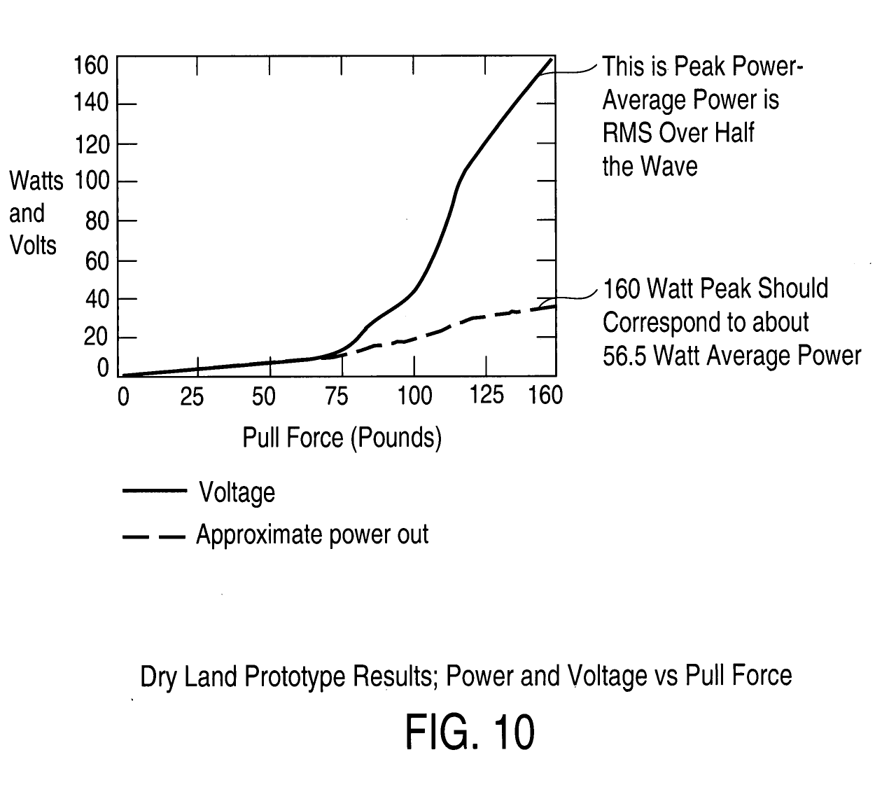

A total of 160 Watts of peak power was generated from this system in a laboratory environment, at relatively modest pull-forces (150 lbs & less out of nearly 300 lbs buoyancy potentially available from the AS buoy). FIG. 10 shows measured pull force vs. power out. It is important to note that our pull force scale was not high quality and force measurements were made with human eyes, and though we used a very nice Fluke voltmeter, human eyes noted the peak power levels, so this likely explains much of the unruly nature of the graph. We did however repeat the experiment numerous times, and were able to achieve in excess of 150 Watts of peak power regularly and repeatedly, which we feel bodes quite well for achieving 50 Watts average power in the ocean (when the waves cooperate).

### Fabrication Of Ocean-Going Prototype

Next a mechanically identical, but waterproof prototype was constructed for the ocean trials.

### Results Of Experiments In The Ocean

Applicants took the waterproof version of our wave energy prototype to the Kilo Nalu test range on Oahu. Though peak power on the day of the final test was about 52.4 Watts due to the ˜0.3 meter waves present that day (and hence the corresponding average power over time is less), we are fairly confident that at higher wave states we can generate up to 160 Watts peak, corresponding to approximately 56 Watts average power, without catastrophic failure given large enough waves as our laboratory tests that were conducted up to this power level. Because of the orientation of the box in the water and last minute changes to the retract spring, the average power calculation will have to be revisited in the near future for the tested conditions.

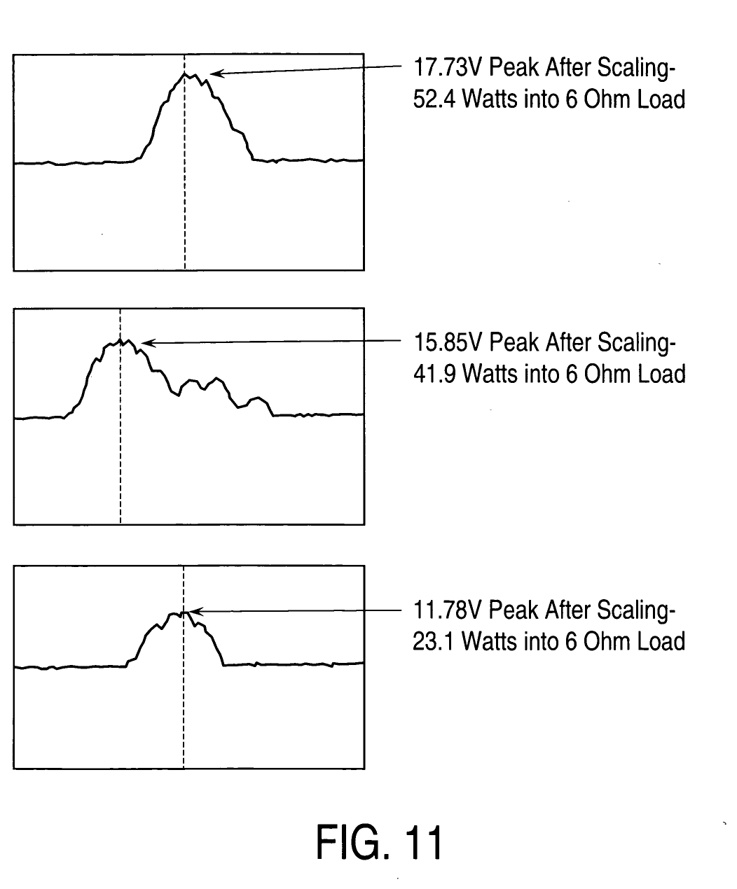

FIG. 11 shows several example plots of voltage vs. time as the wave lifted our wave energy buoy. Wave heights ranged from 0.25 to 0.32 m during the test period (see Table 1). This voltage was applied to a 6 ohm load (0.1% tolerance) located within the machine itself (and previously calibrated with our homemade dynamometer). As a further demonstration of the concept, we conducted in ocean (near-shore) experiments with the prototype float/anchor/pull-cord system to generate over 50 W of peak power—we anticipate that much more power could be created with bigger waves.

### Other Anchor Devices

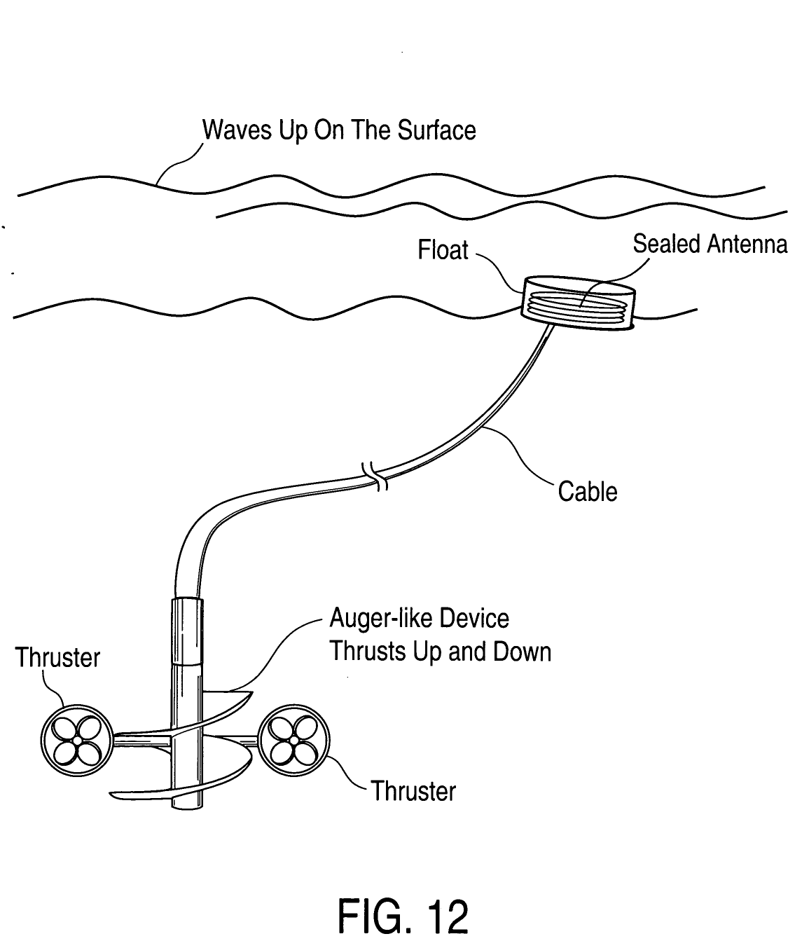

In addition to underwater sails and sea anchors, other anchor devices may provide improved performance. FIG. 12 shows an auger-type anchor with tiny electric driven thrusters that threads the anchor up and down to increase the tension in the cable during increasing wave height.

### Variations

While the present invention has been described in terms of specific preferred embodiments and the prototype, the reader should understand that many changes and modifications can be made within the scope of the invention. For example, the systems can be made much smaller and much larger. Other techniques similar to underwater sails and sea anchors can be used to provide tension to the buoy in very deep water. Other tension elements could be used in place of the steel rope that provides the tension to rotate the spool mechanism. Anchors can be adapted to provide much more drag in the up direction than the down direction. Other floating devices that ride up and down on waves could be used in place devices having a conventional buoy shape as described in the specification. So the scope of the invention should be determined by the appended claims and their legal equivalence.

What is claimed is:

1. An electric power generating buoy comprising:
A) float element adapted to float up and down following wave motion,
B) an electric generator system comprising
1) an electric generator comprising a rotor,
2) a spring loaded spool mechanism adapted to drive the rotor of the electric generator when spun,
C) an anchor element
D) a tension element adapted attached to an anchor and the spring loaded spool mechanism and adapted to spin the spring loaded spool mechanism to generate electric current when wave action causes the float element to rise relative to the anchor element.

2. The electric power generating buoy as in claim 1 wherein the electric generating system also comprises a voltage regulator and a battery.

3. The electric power generating buoy as in claim 1 wherein the anchor element is a underwater sail.

4. The electric power generating buoy as in claim 1 wherein the anchor element is a sea anchor.

5. The electric power generating buoy as in claim 1 wherein the anchor element is an auger-type anchor comprising a thread type element and electric driven thrusters.

6. The electric power generating buoy as in claim 1 wherein the anchor is a dead weight.

7. The electric power generating buoy as in claim 1 wherein the anchor is comprises electric driven thrusters to provide station keeping.
